(19) United States
(12) Patent Application Publication
(10) Pub. No.: US 2007/0150899 A1
(43) Pub. Date: Jun. 28, 2007

(54) Semaphore management method and computer product

(75) Inventors: Shigeki Nankaku, Tokyo (JP); Teiichiro Inoue, Tokyo (JP); Michiyasu Hiramatsu, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/471,626

(22) Filed: Jun. 21, 2006

(30) Foreign Application Priority Data
Dec. 27, 2005 (JP) 2005-375386

(51) Int. Cl. G06F 9/46

(52) U.S. Cl. 718/107

(57) ABSTRACT

A semaphore handle is retrieved from a symbol-handle table, which stores a semaphore handle of a semaphore controlling a resource in association with a resource symbol included in a semaphore operation command issued by a task. In case of an “Acquire semaphore” command, the semaphore indicated by the retrieved semaphore handle is acquired, and the resource managed by the acquired semaphore is assigned to the task that issued the “Acquire semaphore ” command. In case of a “Release semaphore” command, the semaphore indicated by the retrieved semaphore handle is released, and the resource managed by the semaphore is released from the task that issued the “Release semaphore” command.

### BACKGROUND OF THE INVENTION

1. Field of the Invention

The present invention relates to a method of managing semaphores that are used for executing exclusive control of resources in a multi-tasking operating system.

2. Description of the Related Art

In a multi-tasking operating system, semaphores are largely used for implementing exclusive control of resources. A task that needs to exert an exclusive control over the resource first creates a semaphore by a “Create semaphore” command. During semaphore creation, a pointer to the semaphore structure, an index of the semaphore structure array, or a handle provided by the operating system for operating the semaphore (hereinafter, “semaphore handle”) is returned to the processor executing the task. The processor executing the task acquires the semaphore by an “Acquire semaphore” command, with the semaphore handle specified in the command, and gains exclusive access to the resource. After the resource has been used, the processor releases the resource by a “Release resource” command, with the semaphore handle specified in the command.

The term “task” refers to a program created by a user for realizing an intended function. The user needs to know the correlation between the semaphore handle and the resource for implementing exclusive control over the resource using the commands for operating the semaphore (Create semaphore, Acquire semaphore, and Release semaphore).

However, the semaphore handle being a numerical value makes it difficult for establishing a correlation between the semaphore handle and the resource intuitively, thereby making the management of the correlation between the semaphore handle and the resource a difficult task.

As a remedy to this problem, a resource management method is disclosed in Japanese Patent Laid-Open Publication No. H5-81048 in which the resources are managed by assigning them names (that is, representing the resources by symbols), thus implementing smooth program (task) creation and diversion and good resource management.

Specifically, the task notifies a resource management module of the symbol of the resource in use. An identifier managing unit of the resource management module acquires the symbol from a task, and searches an identifier management table containing resource symbols and identifiers (semaphore handles) in a correlated form, finds an unassigned semaphore handle, registers the semaphore handle in association with the acquired symbol, and sets the semaphore handle as “in use”. The identifier managing unit also notifies the semaphore handle to the task via the identifier assigning unit. Using the semaphore handle, the task issues a system call to the multi-tasking operating system, and uses the resource. After the resource has been used, the task notifies the resource management module of the semaphore handle. The identifier managing unit accepts the semaphore handle via the identifier assigning unit of the resource management module, deletes the symbol associated with the notified semaphore handle in the identifier management table, and sets the semaphore handle as “not in use”.

In the technology disclosed in Japanese Patent Laid-Open Publication No. H5-81048, an identifier management table is provided, which stores resource names represented by symbols, and semaphore handles in correlation. The task notifies the symbol to the resource management module that manages the identifier management table, and in response, is notified of the semaphore handle assigned to the symbol, using which the task operates the resource. Thus, the user creating the task can do so with the symbol alone and does not need to know the correlation between the symbol representing the resource and the semaphore handle.

In the conventional technology disclosed in Japanese Patent Laid-Open Publication No. H5-81048, the user does not have to know the correlation between the symbol and the semaphore number. However, to use the semaphore using the semaphore handle returned by the resource management module, the user must manage the semaphore handle within the task.

Further, in the conventional technology, first the task has to acquire the semaphore handle associated with the symbol, and then acquire the semaphore using the semaphore handle. That is, the task needs to issue two commands, namely, “Acquire semaphore handle” and “Acquire semaphore”, thus increasing the number of steps.

Further, for using the semaphore, the task creates a semaphore structure corresponding to the semaphore by “Create semaphore” command, and acquires the semaphore handle of the semaphore corresponding to the created semaphore structure. However, the acquired semaphore handle has to be notified to all the tasks using the created semaphore.

### SUMMARY OF THE INVENTION

It is an object of the present invention to at least solve the problems in the conventional technology.

According to an aspect of the present invention, a method of semaphore management, implemented in a multi-tasking operating system that performs exclusive control of resources using semaphores, the method includes receiving from a task, a semaphore operation command for exclusive control of a resource, where the semaphore operation command includes a resource symbol specifying the resource to be controlled; managing a symbol-handle table, including searching and retrieving from the symbol-handle table, a semaphore handle associated with the resource symbol included in the semaphore operation command, where the symbol-handle table stores a resource symbol identifying a resource in association with a semaphore handle identifying the semaphore controlling the resource; acquiring a semaphore based on semaphore information of the semaphore corresponding to retrieved semaphore handle, if the semaphore operation command is an “Acquire semaphore” command, and assigning the resource controlled by acquired semaphore to a task that issued the “Acquire semaphore” command, where the semaphore information specifies a usage status of the semaphore, and is registered in a semaphore structure corresponding to the semaphore; and releasing a semaphore based on the semaphore information of the semaphore corresponding to the retrieved semaphore handle, if the semaphore operation command is a “Release semaphore” command, and releasing the resource controlled by released semaphore from a task that issued the “Release semaphore” command.

According to another aspect of the present invention, a computer-readable recording medium that records thereon a computer program for semaphore management, implemented in a multi-tasking operating system that performs exclusive control of resources using semaphores, the computer program including instructions which, when executed, cause a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a multi-tasking system in which a semaphore management method according to the present invention is implemented;

FIG. 2 is a flowchart for explaining an “Acquire semaphore” command of the multi-tasking system;

FIG. 3 is a flowchart for explaining a “Release semaphore” command of the multi-tasking system; and

FIG. 4 is another flowchart for explaining an “Acquire semaphore” command of the multi-tasking system.

### DETAILED DESCRIPTION OF THE PREFERRED EMBODIMENTS

Exemplary embodiments of the present invention are explained in detail below, with reference to the accompanying drawings. The invention is not limited by the embodiments described herein.

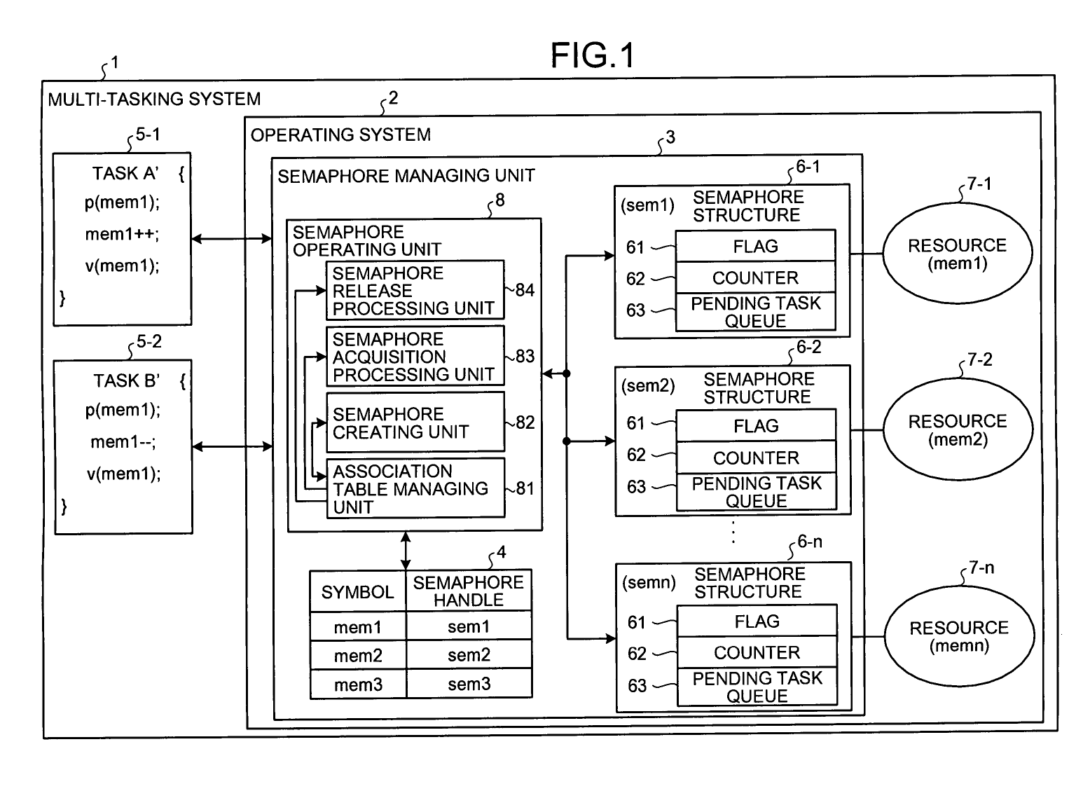

An embodiment of the present invention is explained next with reference to FIG. 1 through FIG. 3. FIG. 1 is a schematic of a multi-tasking system 1 in which a semaphore management method according to the present invention is implemented. The multi-tasking system 1 mainly includes an operating system 2 and a plurality of (two, in this example) tasks 5 (represented by reference numerals 5-1 and 5-2) that are run under the management of the multi-tasking system 1. The operating system 2 includes ‘n’ resources 7 (represented by 7-1 through 7-n, where in is a natural number), and a semaphore managing unit 3 that assigns and releases the resources 7 by exclusive control exerted by a semaphore, based on commands from the task 5.

The task 5 represents the programs created by a user, and includes various commands for realizing intended functions. The commands output by the task 5 are semaphore operation commands for operating the semaphores that exert exclusive control over the resources 7. The semaphore operation commands are commands for using the resources 7. The semaphore operation commands include Acquire semaphore (P command in FIG. 1) and Release semaphore (V command in FIG. 1). The P command is for acquiring the semaphore corresponding to the resource 7, to use the resource 7. The V command is for releasing the semaphore corresponding to the resource 7 that has been used, to release the resource 7. When using the commands Acquire semaphore and Release semaphore, the user specifies the symbol pre-assigned to the intended resource 7.

The resources 7 may be memory, printer, etc., used by the operating system 2, and each of the resources 7 is assigned a symbol. A symbol easily recognized by the user can be assigned to the resource 7. In FIG. 1, the resource 7-1 is assigned the symbol meml, the resource 7-2 is assigned the symbol mem2, . . . , and the resource 7-n is assigned the symbol memn.

The semaphore managing unit 3 includes semaphore structures 6 (represented by 6-1 through 6-n), a symbol-handle association table 4, and a semaphore operating unit 8. The semaphore structures 6 are arranged in a predetermined sequence (as a semaphore structure array), and each semaphore structure 6 is associated with the resource 7 it has exclusive control over. The semaphore managing unit 3 recognizes each semaphore structure 6 by a distinctive index or pointer to the semaphore structure array.

In FIG. 1, the semaphore structure 6-1 is associated with the semaphore that has exclusive control over the resource 7-1, the semaphore structure 6-2 is associated with the semaphore that has exclusive control over the resource 7-2, and the semaphore structure 6-n is associated with the semaphore that has exclusive control over the resource 7-n. The index of the semaphore structure 6-1 is sem1, the index of the semaphore structure 6-2 is sem2, and the index of the semaphore structure 6-n is semn. The indices of the semaphore structures 6 are numerical values. The operating system 2 assigns a handle to each semaphore (hereinafter, “semaphore handle”). The semaphore handle is used for performing semaphore operations. In the present embodiment, the semaphore handle has the same value as the index of the semaphore structure 6 corresponding to the semaphore.

The semaphore structure 6 contains semaphore information related to the usage status of the semaphore in question. The semaphore information includes a flag 61 that contains status or attribute of the semaphore, a counter 62 that contains the current value of the semaphore, and a pending task queue 63 that contains a process ID of the task 5 waiting to use the semaphore.

The symbol-handle association table 4 contains the semaphore handles of the semaphores associated with the symbols of the resources 7 the semaphores have exclusive control over. When the task 5 issues a semaphore operation command, the semaphore operating unit 8 acquires or releases the semaphore based on the symbol-handle association table 4 and the semaphore structure 6.

The semaphore operating unit 8 includes an association table managing unit 81 that manages the symbol-handle association table 4, a semaphore creating unit 82 that creates the semaphore structure 6 corresponding to the semaphore, a semaphore acquisition processing unit 83 that implements a semaphore acquisition process based on the semaphore structure 6, and a semaphore release processing unit 84 that implements a release process of the semaphore based on the semaphore structure 6.

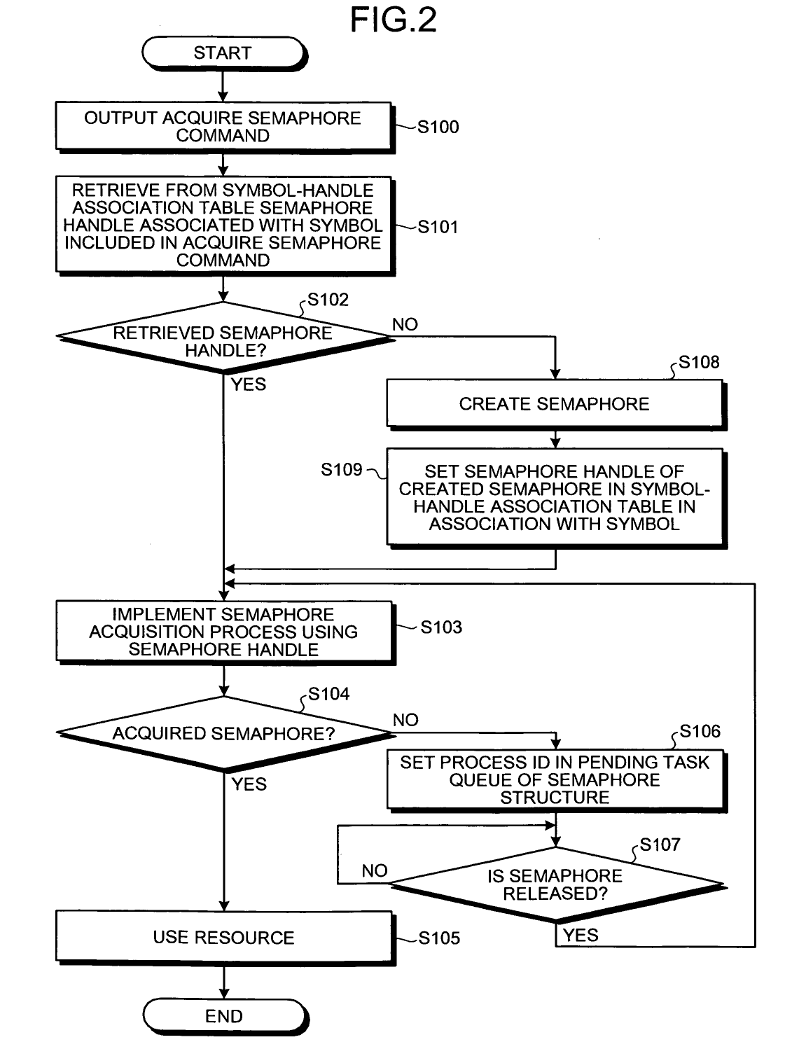

The functioning of the multi-tasking system 1 implementing the semaphore managing method according to the present invention is explained next with reference to FIG. 1 through FIG. 3. The functioning of the Acquire semaphore command is explained first with reference to the flowchart shown in FIG. 2 as well as with reference to FIG. 1. The task 5 outputs (issues) to the semaphore operating unit 8, an “Acquire semaphore” command including in the command, the symbol of the resource 7 to be used (step S100).

Upon receiving the Acquire semaphore command, the association table managing unit 81 of the semaphore operating unit 8 retrieves from the symbol-handle association table 4, the semaphore handle corresponding to the symbol included in the Acquire semaphore command (step S101).

If the symbol-handle association table 4 contains the semaphore handle corresponding to the symbol included in the Acquire semaphore command (“Yes” at step S102), the association table managing unit 81 sends an Acquired semaphore notification to the semaphore acquisition processing unit 83, including the retrieved semaphore handle therein.

Upon receiving the Acquired semaphore notification, the semaphore acquisition processing unit 83 implements the semaphore acquisition process using the semaphore handle included in the Acquired semaphore notification (step S103). Specifically, the semaphore acquisition processing unit 83 checks the count value in the counter 62 of the semaphore structure 6 corresponding to the semaphore handle included in the Acquired semaphore notification, to determine whether the semaphore can be acquired. The count value indicates the current value of the semaphore corresponding to the semaphore structure 6. The semaphore acquisition processing unit 83 determines that the semaphore cannot be acquired if the count value is 0, and the semaphore can be acquired if the count value is not 0. If it is determined that the semaphore can be acquired, the semaphore acquisition processing unit 83 decrements the count value of the counter 62 of the semaphore structure 6 corresponding to the semaphore handle included in the Acquired semaphore notification, and acquires the semaphore.

Upon acquiring the semaphore (“Yes” at step S104), the semaphore acquisition processing unit 83 notifies the task 5 that the semaphore has been acquired. After this notification, the task 5 implements the intended process by using the resource 7 exclusively controlled by the acquired semaphore (step S105).

If it is determined that the semaphore cannot be acquired (“No” at step S104), the semaphore acquisition processing unit 83 sets the process ID of the task 5 that output the Acquire semaphore command, into the pending task queue 63 of the semaphore structure 6 corresponding to the semaphore handle (step S106).

When another task 5 releases the awaited semaphore (step S107), the semaphore acquisition processing unit 83 implements the semaphore acquisition process and acquires the semaphore, and notifies the task 5 that the semaphore has been acquired, and the task 5 executes the intended process using the resource 7 exclusively controlled by the acquired semaphore (steps S103 through S105). While acquiring the semaphore from the task 5 awaiting the semaphore, the semaphore acquisition processing unit 83 decrements the value of the counter 62 and deletes the process ID of the task 5 from the pending task queue 63.

If the semaphore handle cannot be retrieved from the symbol-handle association table 4, that is, if the symbol-handle association table 4 does not include an entry of the symbol included in the Acquire semaphore command and its corresponding semaphore (“No” at step S102), the association table managing unit 81 sends a Create semaphore command to the semaphore creating unit 82.

Upon receiving the Create semaphore command, the semaphore creating unit 82 adds a new semaphore structure 6 to the semaphore structure array to create a semaphore (step S108). Next, the semaphore creating unit 82 sends the association table managing unit 81 a creation completion notification, including in it the semaphore handle provided by the operating system 2 during semaphore creation.

Upon receiving the creation completion notification, the association table managing unit 81 sets the semaphore handle included in the creation completion notification into the symbol-handle association table 4, in association with the symbol included in the Acquire semaphore command (step S109). The association table managing unit 81 notifies the Acquire semaphore command to the semaphore acquisition processing unit 83, including therein the semaphore handle present in the creation completion notification, that is, the semaphore handle set in the symbol-handle association table 4.

The semaphore acquisition processing unit 83 implements the semaphore acquisition process, and notifies the task 5 that the semaphore has been acquired, and the task 5 executes the intended process using the resource 7 exclusively controlled by the acquired semaphore (steps S103 through S105).

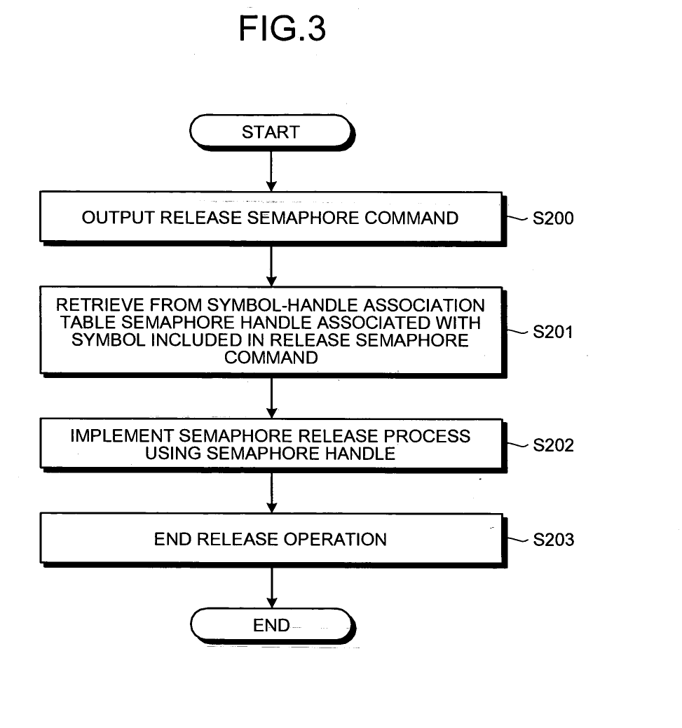

The functioning of the Release semaphore command is explained next with reference to the flow chart in FIG. 3 as well as with reference to FIG. 1. When releasing the acquired semaphore with the Release semaphore command, the task 5 outputs a Release semaphore command to the semaphore operating unit 8, including in the command the symbol of the resource 7 to be released (step S200).

Upon receiving the Release semaphore command, the association table managing unit 81 of the semaphore operating unit 8 retrieves from the symbol-handle association table 4, the semaphore handle associated with the symbol included in the Release semaphore command (step S201). The association table managing unit 81 sends a Release semaphore instruction to the semaphore release processing unit 84, including in the instruction the retrieved semaphore handle.

Upon receiving the Release semaphore instruction, the semaphore release processing unit 84 implements a semaphore release process using the semaphore handle included in the Release semaphore instruction (step S202). Specifically, the semaphore release processing unit 84 increments the count value of the counter 62 of the semaphore structure 6 corresponding to the semaphore handle.

The semaphore release processing unit 84 notifies the task 5 that the semaphore has been released. The task 5 recognizes this step as the end of the semaphore release process, and executes the next command (step S203).

Thus, according to the present embodiment, the symbol-handle association table 4 contains, in an associated form, the symbol that functions as an identifier for the resource 7, and the semaphore handle that functions as an identifier for the semaphore that controls the resource 7. The association table managing unit 81 retrieves from the symbol-handle association table 4 the semaphore handle corresponding to the symbol included in the semaphore operating command issued by the task 5. If the semaphore operating command is Acquire semaphore, the semaphore acquisition processing unit 83 acquires the semaphore corresponding to the retrieved semaphore handle and assigns the resource 7 controlled by the acquired semaphore to the task 5 that issued the Acquire semaphore command. If the semaphore operating command is Release semaphore, the semaphore release processing unit 84 releases the semaphore corresponding to the retrieved semaphore handle and releases the resource 7 controlled by the semaphore from the task 5 that issued the Release semaphore command. Consequently, implementation of exclusive control using semaphores can be realized by operating the semaphores using the symbols assigned to the resource 7, obviating the need for managing the semaphore handles within the task 5.

Further, by operating the semaphores using the symbols assigned to the resource 7 and not having to manage the semaphore handles within the task 5, the need for notifying the semaphore handle to all the tasks 5 using the same semaphore is obviated.

Further, according to the present embodiment, if the semaphore handle associated with the symbol included in the semaphore operation command issued by the task 5 is not set in the symbol-handle association table 4, the semaphore creating unit 82 generates a new semaphore structure 6 to create a semaphore, and the association table managing unit 81 associates the semaphore with the symbol included in the semaphore operation command. The semaphore creating unit 82 sets the semaphore handle of the created semaphore in the symbol-handle association table 4, and the semaphore acquisition processing unit 83 acquires the semaphore. Consequently, semaphore creation and semaphore acquisition are carried out by a single command, reducing the number of steps of the task 5.

Further, for exerting exclusive control using semaphore, semaphores can be operated using the symbol of resource 7 and without having to manage the semaphore handle within the task 5. Consequently user is spared the additional labor when creating the task 5. Additionally, errors relating to associating the semaphores with the symbols are avoided, improving the quality of the program.

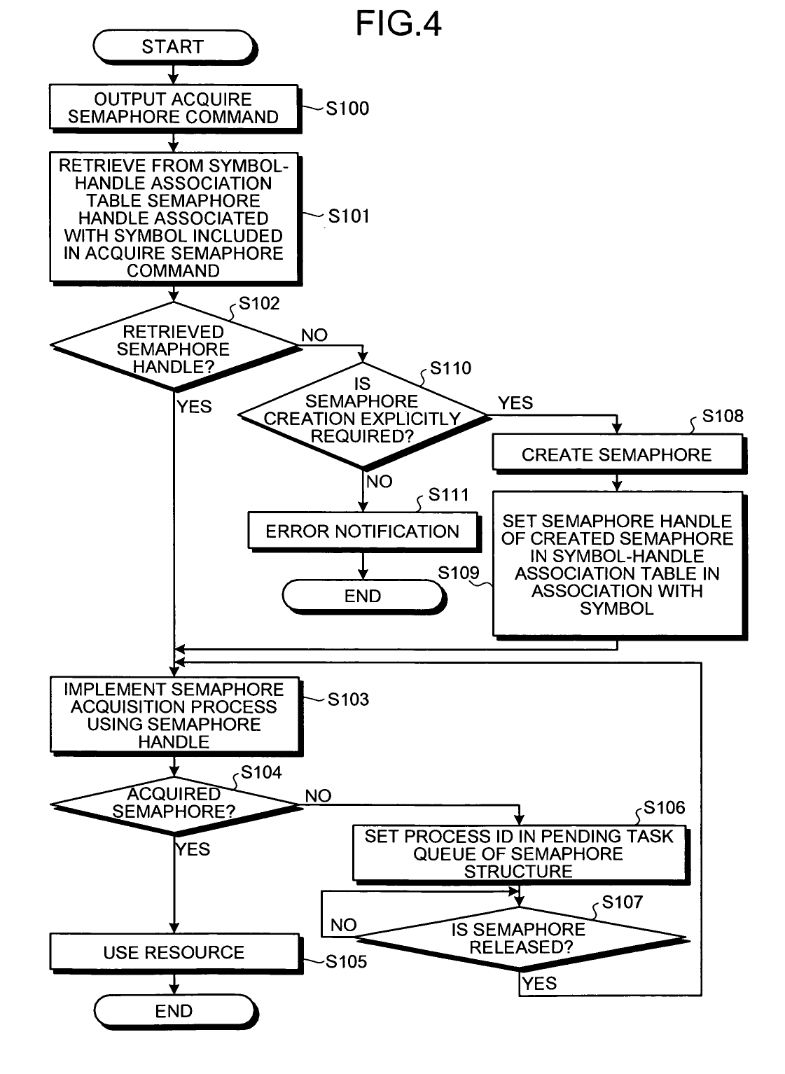

In the present embodiment, when the semaphore handle can not be retrieved from the symbol-handle association table 4 during the Acquire semaphore command, the semaphore is created unconditionally. As shown in a flowchart in FIG. 4, a step, namely step S110, can be introduced for determining whether there is an explicit need for semaphore creation before actually creating the semaphore at step S108 of the flow chart shown in FIG. 2. If the semaphore needs to be created, the semaphore can be created, otherwise, an error notification can be sent to the task 5 (step S111). Explicit semaphore creation involves including the Create semaphore command within the Acquire semaphore command. In this case, the task 5 should be made to use two different Acquire semaphore commands, one for the instance when the semaphore is set in the symbol-handle association table 4, and the other for the instance when the semaphore is not set in the symbol-handle association table 4 and in which case the semaphore has to be first created and then set in the symbol-handle association table 4.

The functions of the association table managing unit 81, the semaphore creating unit 82, the semaphore acquisition processing unit 83, and the semaphore release processing unit 84 of the semaphore operating unit 8 according to the present embodiment can also be realized by providing a program that can be executed by a microprocessor such as a central processing unit (CPU), etc., operated by the operating system 2.

According to the present invention, implementation of exclusive control using semaphores can be realized by operating the semaphores using the symbols assigned to the resource, obviating the need for managing the semaphore handles within the task.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of semaphore management, implemented in a multi-tasking operating system that performs exclusive control of resources using semaphores, the method comprising:
receiving from a task, a semaphore operation command for exclusive control of a resource, wherein the semaphore operation command includes a resource symbol specifying the resource to be controlled;
managing a symbol-handle table, including searching and retrieving from the symbol-handle table, a semaphore handle associated with the resource symbol included in the semaphore operation command, wherein the symbol-handle table stores a resource symbol identifying a resource in association with a semaphore handle identifying the semaphore controlling the resource;
acquiring a semaphore based on semaphore information of the semaphore corresponding to retrieved semaphore handle, if the semaphore operation command is an “Acquire semaphore” command, and assigning the resource controlled by acquired semaphore to a task that issued the “Acquire semaphore” command, wherein the semaphore information specifies a usage status of the semaphore, and is registered in a semaphore structure corresponding to the semaphore; and
releasing a semaphore based on the semaphore information of the semaphore corresponding to the retrieved semaphore handle, if the semaphore operation command is a “Release semaphore” command, and releasing the resource controlled by released semaphore from a task that issued the “Release semaphore” command.

2. The method according to claim 1, further comprising:
creating a new semaphore structure and a corresponding semaphore, if it is determined during the act of retrieving, that no semaphore handle is registered in the symbol-handle table in association with the resource symbol, and wherein
after the act of creating, the act of managing includes registering in the symbol-handle table, a semaphore handle identifying created semaphore in association with the resource symbol included in the semaphore operation command.

3. A computer-readable recording medium that records thereon a computer program for semaphore management, implemented in a multi-tasking operating system that performs exclusive control of resources using semaphores, the computer program including instructions which, when executed, cause a computer to execute:
receiving from a task, a semaphore operation command for exclusive control of a resource, wherein the semaphore operation command includes a resource symbol that specifies the resource to be controlled;
managing a symbol-handle table, including retrieving from the symbol-handle table, a semaphore handle associated with the resource symbol included in the semaphore operation command, wherein the symbol-handle table stores in associated form, a resource symbol identifying a resource, and a semaphore handle identifying the semaphore controlling the resource;
acquiring a semaphore based on semaphore information of retrieved semaphore handle, if the semaphore operation command is an “Acquire semaphore” command, and assigning the resource controlled by acquired semaphore to a task that issued the “Acquire semaphore” command, wherein the semaphore information specifies a usage status of the semaphore, and is registered in a semaphore structure corresponding to the semaphore; and
releasing a semaphore based on the semaphore information of the retrieved semaphore handle, if the semaphore operation command is a “Release semaphore” command, and releasing the resource controlled by released semaphore from a task that issued the “Release semaphore” command.

4. The recording medium according to claim 3, further causing the computer to execute:
creating a new semaphore structure and a corresponding semaphore, if it is determined during the act of retrieving, that no semaphore handle is registered in the symbol-handle table in association with the resource symbol, and wherein
after the act of creating, the act of managing includes registering in the symbol-handle table, a semaphore handle identifying created semaphore in association with the resource symbol included in the semaphore operation command.
